(19) United States
(12) Patent Application Publication
(10) Pub. No.: US 2007/0266391 A1
(43) Pub. Date: Nov. 15, 2007

(54) System and method for separating multi-workload processor utilization on a metered computer system

(76) Inventors: Philip M. Hoffman, Oreland, PA (US); Jeffery A. Stell, Exton, PA (US); Jessica A. Paragas, Springfield, PA (US); Tatyana Martsun, Philadelphia, PA (US); James Keith Baker, Glen Mills, PA (US); Steven D. Schatz, Eagleville, PA (US); Robert K. Liermann, Downingtown, PA (US); James W. Thompson, West Chester, PA (US)

Correspondence Address: UNISYS CORPORATION, UNISYS WAY, MAIL STATION: E8-114, BLUE BELL, PA, 19424, US

(21) Appl. No.: 11/648,243

(22) Filed: Dec. 29, 2006

Related U.S. Application Data
(60) Provisional application No. 60/795,627, filed on Apr. 27, 2006.

(51) Int. Cl. G06F 9/46

(52) U.S. Cl. 718/106

(57) ABSTRACT

A computing system having multiple processors in which these processors are configured to support a plurality of workload types may provide processing metering by workload types. In such a system, metering provides a measure of the normalized processing throughput utilized by processing tasks for each workload type supported by the system. This metering measures processing throughput for tasks of any given workload type that is performed by a processor configured to support that workload type as well as tasks of that type which may also be performed on a standard processor.

This application claims the benefit from the filing of U.S. Provisional Application Ser. No. 60/795,627, entitled “System And Method For Separating Multi-Workload Processor Utilization On A Metered Computer System” by Hoffman, et al., filed 27 Apr. 2006, the entire content of which is incorporated herein by reference in its entirety.

### FIELD OF THE INVENTION

The present invention relates generally to techniques for providing processing services within a multi-processor computing system, and, in particular, to techniques for providing a workload processing metering for tasks of multiple workload types in a multi-processor computing system.

### BACKGROUND OF THE INVENTION

Initially, Java workloads and non-Java workloads ran together in a single processor set. Java workloads tended to be processor-intensive, thus dominating the processor resources on the system. To alleviate the problem, recently developed servers came up with Secure Java Workload which defined two separate processor sets, one of which is used for Java workloads and the other is used for everything else (standard workloads). Furthermore each processor set could be set to a different level of performance. Thus the processor-intensive Java workload could be set to run at a high processor performance while the standard workload could be set to run at a low level of performance. This works well in a processor capacity-managed system. Details regarding this multi-workload processor based computing system is described in more detail in concurrently filed and commonly assigned U.S. Provisional Patent Application entitled “System And Method For Separating Multiple Workloads Processing In A Single Computer Operating Environment,” by Thompson et al., Attorney Docket No. TN472, Ser. No. 60/795,640, filed 27 Apr. 2006, which is incorporated by reference herein in its entirety.

On processor power metering systems, real-time CPU processor time statistics along with the actual hardware configuration and the processor performance level are used to determine specific metering utilization values. When combined with an interval, the meter values become metering utilization statistics that are accumulated into the system metering values. When Java processors are defined, Java task time is accumulated against Java processors. However when Java processors are not defined, Java tasks will continue to execute and accumulate time against standard processors. Thus metering of the standard processor set does not guarantee that only non-Java task CPU time is accounted in the meters.

### SUMMARY OF THE INVENTION

Problems in the prior art are addressed in accordance with the principles of the present invention by providing a workload processing metering for tasks of multiple workload types in a multi-processor computing system.

In one embodiment, the present invention is a computing system having multiple processors in which these processors are configured to support a plurality of workload types may provide processing metering by workload types. In such a system, metering provides a measure of the normalized processing throughput utilized by processing tasks for each workload type supported by the system. This metering measures processing throughput for tasks of any given workload type that is performed by a processor configured to support that workload type as well as tasks of that type which may also be performed on a standard processor. The computing system providing processing metering for tasks from a plurality of workload types and comprises one or more processor set executing processing tasks associated with a standard workload type, one or more processor sets executing processing tasks associated with a particular workload type, and a server control module for collecting processing time associated with tasks of the standard workload type and with tasks associated the particular workload type.

In another embodiment, the present invention corresponds to a method for providing processing metering for tasks from a plurality of workload types. The method periodically collects processing time for tasks of each of the plurality of workload types running on a processor set associated with the particular workload type, periodically collects processing time for tasks of each of the plurality of workload types by workload type that are running on a standard processor set, saves prior accumulated processing time for tasks of a particular workload type running on a processor set associated with the particular workload type when the processor set changes to process a different workload type, and totals the collected and the saved processing times for each of the plurality of workload types from all processor sets.

In yet another embodiment, the present invention corresponds to a data storage media containing computer readable data encoded with instructions that when executed in a computing system implements a method for providing processing metering for tasks from a plurality of workload types. The method periodically collects processing time for tasks of each of the plurality of workload types running on a processor set associated with the particular workload type, periodically collects processing time for tasks of each of the plurality of workload types by workload type that are running on a standard processor set, saves prior accumulated processing time for tasks of a particular workload type running on a processor set associated with the particular workload type when the processor set changes to process a different workload type, and totals the collected and the saved processing times for each of the plurality of workload types from all processor sets.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 illustrates an example multiple workload processing-based computing system according to an embodiment of the present invention;

FIG. 2 illustrates a general purpose computing system for implementing various embodiments of the present invention;

FIGS. 3a-3b illustrate example embodiments of a multi-processor-based processing system configured as various workload sets according to one embodiment of the present invention;

FIG. 4 illustrates an example of a Fixed Key Information;

FIG. 5 illustrates an example of a Variable Key Information including the format of variable data in the key;

FIG. 6 illustrates an example of a decoded key string according to the present invention;

FIG. 7 illustrates an example of Licensing Two Workloads—Metering Standard and Non-Metering Java;

FIG. 8 illustrates an example embodiment of a Dual Workload CPU Sets and CPU Time Data Structures;

FIG. 9 illustrates an example of a SYSTEMSTATUS Type 25 Normalized Workload CPU Time Documentation;

FIG. 10 illustrates an example of a Meter Report according to the present invention; and

FIG. 11 illustrates a flowchart for an example method for implementing one embodiment of the present invention.

### DETAILED DESCRIPTION

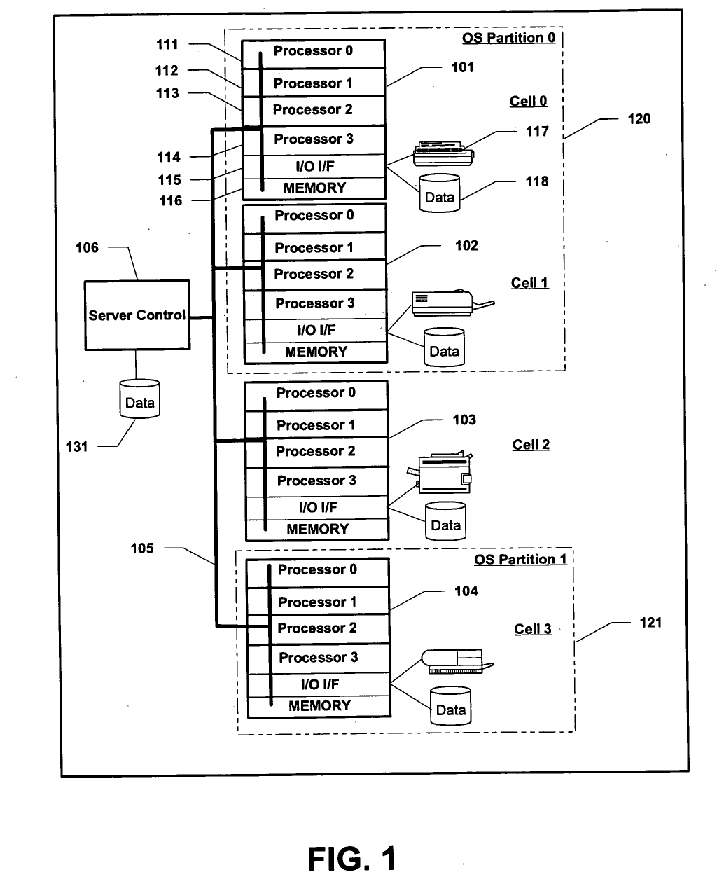

FIG. 1 illustrates an example multiple workload processing-based computing system according to an embodiment of the present invention. In this example, a system 100 is constructed from a set of cells 101-104 that are connected together via a high-speed data bus 105. Also connected to the bus 105 is a server control module 106 that provides supervisory control of the system. Server control module 106 maintains persistent data 131 regarding various configurations of system software that may be enabled.

Two different OS partitions 120-121 are present in the example configuration of FIG. 1. An OS partition is an instantiation of an operating system onto a computing system. The two partitions 120-121 may consist of two instantiations of the same OS. These two partitions 120-121 may also consist of an instantiation of two different operating systems. OS partition 0 120 operates using cells 0 and cell 1 101-102. OS partition 1 121 operates on cell 3 104. Cell 2 102 is currently not in use but may represent a spare cell available if any other cells fail.

Within each cell, a set of processor are present along with system memory and I/O interface modules. For example, cell 0 101 includes processor 0, processor 1, processor 2, and processor 3 111-114, I/O interface module 115, and memory module 116. Peripheral devices 117-118 are connected to I/O interface module 115 for use by any tasks executing within OS partition 0 120. All of the other cells within system 100 are similarly configured with multiple processors, system memory and peripheral devices. While the example shown in FIG. 1 illustrates cells 0 through cells 3 101-104 as being similar, one of ordinary skill in the art will recognize that each cell may be individually configured to provide a desired set of processing resources as needed.

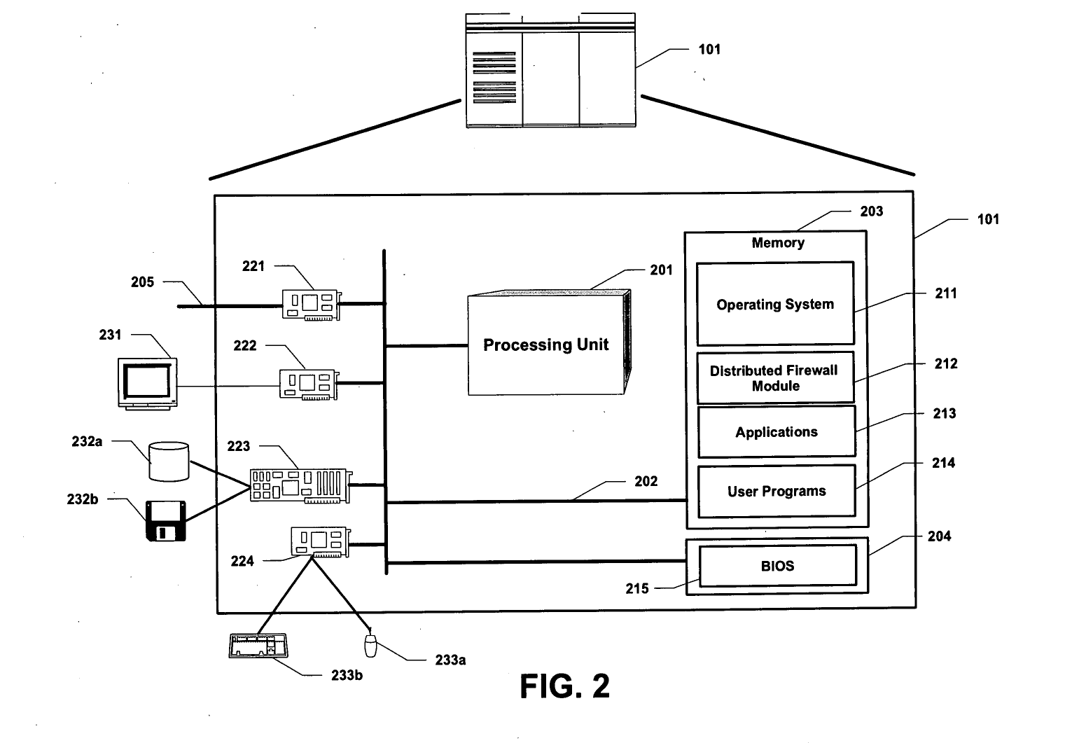

FIG. 2 illustrates a general purpose computing system for implementing various embodiments of the present invention. Those of ordinary skill in the art will appreciate that the computing system 300 may include many more components than those shown in FIG. 2. However, the components shown are sufficient to disclose an illustrative embodiment for practicing the present invention. As shown in FIG. 2, computing system 101 is connected to WAN/LAN 100, or other communications network, via network interface unit 221. Those of ordinary skill in the art will appreciate that network interface unit 221 includes the necessary circuitry for connecting computing system 101 to WAN/LAN 100, and is constructed for use with various communication protocols including the TCP/IP protocol. Typically, network interface unit 221 is a card contained within computing system 101.

The computing system 101 also includes processing unit 201, video display adapter 222, and a mass memory, all connected via bus 202. The mass memory generally includes RAM 203, ROM 204, and one or more permanent mass storage devices, such as hard disk drive 232a, a tape drive, CD-ROM/DVD-ROM drive, and/or a floppy disk drive 232b. The mass memory stores operating system 221 for controlling the operation of the programmable computing system 101. It will be appreciated that this component may comprise a general purpose server operating system as is known to those of ordinary skill in the art, such as UNIX, MAC OS X™, LINUX™, or Microsoft WINDOWS XP™. Basic input/output system (“BIOS”) 215 is also provided for controlling the low-level operation of computing system 101. While the example of FIG. 2 contains a single processor-based system, one of ordinary skill in the art will recognize this computing system may contain multiple processing modules as discussed above in reference to FIG. 1.

The mass memory as described above illustrates another type of computer-readable media, namely computer storage media. Computer storage media may include volatile and nonvolatile, removable and non-removable media implemented in any method or technology for storage of information, such as computer readable instructions, data structures, program modules or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data for providing a host computing system. More specifically, the mass memory stores applications including host application program 213, user programs 214, and distributed firewall module 212.

The computing system 101 also comprises input/output interface 214 for communicating with external devices, such as a mouse 233a, keyboard 233b, scanner, or other input devices not shown in FIG. 2. Likewise, computing system 101 may further comprise additional mass storage facilities such as CD-ROM/DVD-ROM drive and hard disk drive 232a. Hard disk drive 232a is utilized by computing system 101 to store, among other things, application programs, databases, and program data used by various application programs.

The embodiments of the invention described herein are implemented as logical operations in a general purpose computing system. The logical operations are implemented (1) as a sequence of computer implemented steps or program modules running on a computer system and (2) as interconnected logic or hardware modules running within the computing system. This implementation is a matter of choice dependent on the performance requirements of the computing system implementing the invention. Accordingly, the logical operations making up the embodiments of the invention described herein are referred to as operations, steps, or modules. It will be recognized by one of ordinary skill in the art that these operations, steps, and modules may be implemented in software, in firmware, in special purpose digital logic, and any combination thereof without deviating from the spirit and scope of the present invention as recited within the claims attached hereto. This software, firmware, or similar sequence of computer instructions may be encoded and stored upon computer readable storage medium and may also be encoded within a carrier-wave signal for transmission between computing devices.

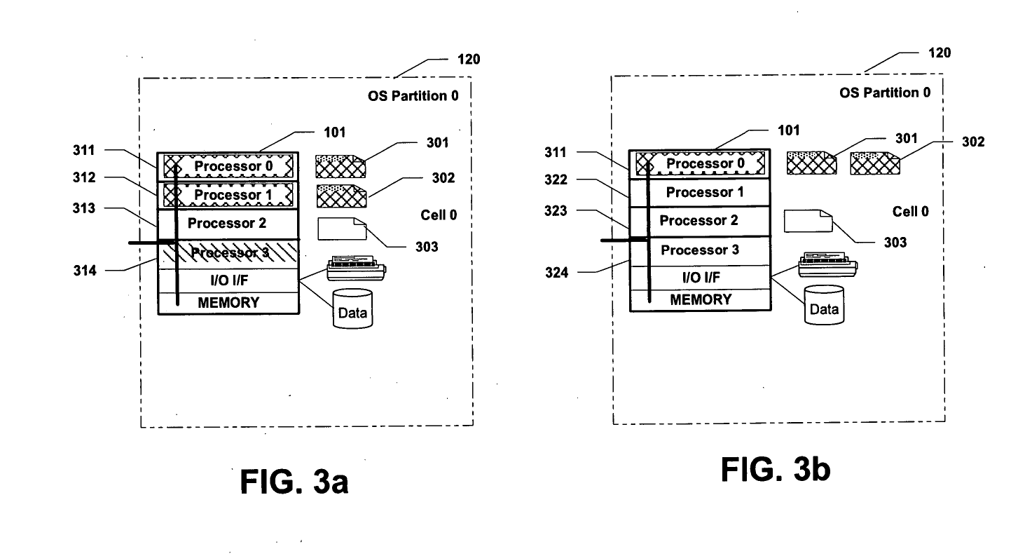

FIGS. 3a-3b illustrate example embodiments of a multi-processor-based processing system configured as various workload sets according to one embodiment of the present invention. In these two embodiments, OS partition 0 120 of FIG. 1 is shown using just cell 0 101. In the embodiment of FIG. 3a, processor 0 and processor 1 311-312 are shown operating as Java processors. Processor 2 313 is shown operating as a standard processor and processor 3 314 is not enabled for use and may act as a spare processor.

Java processors 311-312 in this example correspond to processors that are configured to efficiently perform Java tasks 301-302. These processors may be configured to utilize different microcode instructions applicable to Java tasks. These processors may possess customized hardware to support the Java tasks. Finally, these processors may be configured to operate at a particular performance level relative to a maximum possible processing throughput to adequately support Java tasks.

Standard processor 313 corresponds to a processor that is configured to support most other processing tasks 303 present within OS partition 0 120. This processor 313 may not necessarily possess customize microcode or specialized processing hardware. Additionally, processors may be configured to operate at a different performance level relative to a maximum possible processing throughput to provide cost effective processing. In some embodiments of multi-processor systems, users are billed for the system providing a pre-defined processing throughput. When a higher level of processor performance provided, a user may be charged a higher cost. As such, processing levels for the standard processors may be set accordingly.

When a task is executed within an OS partition 120, the task is assigned to a particular processor depending upon whether the tasks is a Java task 301 or a standard task 303. A child task 302 that is created by an existing task 301 is classified as a task of the same workload type. Java tasks 301-302 are performed by Java processors 311-312 when they are present within a configured system. If a Java processor is not included within a configured system, the Java tasks 301-302 are performed by a standard processor.

FIG. 3b illustrates the one cell example from FIG. 3a where cell 0 101 is configured to possess only one Java processor 311 and three standard processors 322-324. In this configuration, Java tasks 301-302 execute on Java processor 311 and standard task 303 may execute on any of the standard processors 322-324. The number of Java processors and the number of standard processors may be varied within various configurations for a OS partition 120 as required by a user to support a particular mix of tasks to be performed. When the mix of processing tasks are changed, a different configuration for the OS partition may be configured.

Throughout the entire description of various embodiments of the present invention, examples for two workload types, Java and standard tasks, are described. The choice of using two types of task for possible workload types has been made for illustrative purposes only and is not intended to limit the invention in any way. Alternate workload sets in which processing tasks may be organized into a common set of tasks to be performed on its own processor may be used in place of Java processors and Java tasks as described herein. The characteristics for the alternate workload type processor may be configured as necessary to support the particular workload type and its corresponding tasks.

Similarly, systems may be configured to contain any number of workload types. In such an embodiment, processors from a multi-processor system of FIG. 1 may be assigned to each of the custom workload types (i.e. Java, image processing, encryption, speech processing, etc.) with tasks of each type of workload. One standard processor is typically included for use by general tasks including OS related tasks. Tasks from a given workload type will be assigned to a processor of its type, if one such a processor exists. If no processor of a particular workload type exists in the system, the task is performed by a standard processor.

The solution to the problem must take into account several factors: how the system metering is licensed: Prior metering systems metered the processors homogenously—no workload differentiation, all tasks metered at equal weight. This method was impractical for processor-intensive Java workloads. The new metering system separates Java workloads from non-Java workloads and meters only the non-Java workload. Subsequent meter systems may separately meter Java workloads and non-Java workloads. The workload group or target processor set that each task is assigned to must be known.

Each processor must be assigned to either the standard processor set or Java processor set. Each processor set must be assigned a specific level of performance (i.e., each CPU in the set is set to the same performance level).

Metering values are calculated using: Accumulated CPU time statistics (how many total busy CPU seconds were accumulated); The CPU configuration (how many processors and how close are the respective processor memory caches); The CPU performance level (how fast were each of the processors set to run); A metering time interval (metering values are updated once every minute).

While metered processing power utilization is not the same as CPU time resource utilization, CPU time resources consumed is one of the factors used in calculating metered processing power resources consumed. Currently, every processor has a set of CPU time counters that is updated every time a task is executing on that processor. This invention creates a new array of processor time counters in which there is one entry for every workload and one array for every processor. Every time a task is executing on a processor, the normal CPU time counter is updated (that has not changed) and the workload counter is updated for that processor. If the executing task is a Java workload, the Java workload counter is updated. If the executing task is a standard workload, the workload counter is updated. The time is accumulated in real-time. The task target processor set is the entity that identifies which workload counter should be updated.

So non-Java CPU time is accumulated on a processor-by-processor basis and Java CPU time is accumulated on a processor-by-processor basis. But previously, it was also said that each processor set can be running at a different level of performance. Thus from one processor to the next, the value of a CPU second may not be the same. The concept of a normalized CPU second is invented to fix this discrepancy. Each processor is actually running a level of performance that is less than or equal to “native” performance. Normalized CPU time effectively applies an exchange rate that converts actual CPU time into CPU time if it were running on a native processor. So if a task is executing on a CPU for 1 second and the CPU is throttled at 50%, the actual CPU time is 1 CPU second and the normalized CPU time is 0.5 CPU seconds.

Normalized CPU time is maintained by the operating system on both a task basis and a workload basis. This enables direct comparison of CPU resources used even when (1) each processor may be running at a different level of performance at any instance, and (2) the operating system may adjust the level of performance for any processor from one instance to the next. Thus back end billing programs that rely upon CPU resources consumed and metering that uses CPU resources consumed to calculate meter values will use this type of CPU resource consumption information.

A number of system interfaces are defined that provides users the ability to query normalized task CPU time and normalized workload CPU time. For metering systems, normalized workload CPU times are used in determining the workload metering utilization values. For new metering systems, a SYSTEMSTATUS type 25 interface is used to coalesce the system-wide processor time accounting information from all of the processors into a single time accounting array.

Thus there is sufficient information to calculate the interval meters. For new metering systems, meters are updated every minute. Metering values for workload differentiated metering systems use the same metering calculation function previously described, but factors in the normalization of the CPU time because workloads may have crossed over to processors that are not the normal processors associated with that workload.

Metering values on workload differentiated systems are calculated using: Accumulated normalized CPU time statistics for that workload; Calculate adjusted elapsed CPU time statistics reflecting target processor set (if configured) or standard processor set (if target processor set is not configured); The CPU configuration (how close are they to each other with respect to their respective processor memory caches); CPU set performance level (the set associated with the prior adjustment); and A metering time interval (metering values are updated once every minute).

Furthermore, workload differentiation allows for metering licensing variations that are more suited to the product that is being delivered. For new metering systems, marketing has decided to license metered non-Java (or standard) performance and to provide an optional license for unmetered Java performance. This allows customers to run a metering system for their normal workloads while at the same time develop their Java environment in a non-interfering environment that does not accumulate any monthly charges.

The following are new features of this invention: This invention provides a means to license multiple workloads in a single partition of which one or more of the workloads is metering. This invention provides a means to independently specify which workloads are metering and which are controlled by normal capacity management. This invention provides a means to separate CPU statistics by workload when each workload is executing on the intended workload processor set. This invention provides a means to separate CPU statistics by workload when the workload is executing on the backup processor set. This invention provides a means to normalize all CPU statistics for all workloads gathered by any processor so that accumulated CPU statistics can be compared meaningfully. This invention provides a means to return the normalized workload CPU times in a single user interface. This invention provides a means to obtain the accumulated normalized workload CPU times and to recalculate adjusted elapsed CPU times for any workload for a given interval the purpose of update metering values for that workload.

The separation of workloads into multiple processor sets has been implemented in prior multi-processor computing systems. These prior systems were capacity licensed (non-metering) systems that were licensed for “N” Java processors that were to be used just for the Java workload and a customer purchased amount of performance that is to be used for everything else (the standard workload). When the partition would start, Java tasks would automatically execute on the Java processors and non-Java tasks would automatically execute on the standard processors.

Some restrictions of this model include: (1) Limited to the licensed number of Java processors (i.e., “N+1” Java processors are not allowed); and (2) Must have at least one standard processor online. The standard processor is the only processor that can execute any task. Therefore at least one standard processor must be online at any time. Attempts to DOWN the last standard processor results in automatic conversion of one of the online Java processors into a standard processor. If one were to use the concept of the separation of processors sets for the basis for workload metering, simplistic workload metering algorithms would monitor the CPU time accumulated against each processor set, use the processor set level of performance information along with the processor set configuration information and the interval, and come up with an incremental metering utilization value for the workload during the prior interval. The concept is simple and is analogous with what is done with single workload metering on other metering system. Where these prior methods of metering falls short is in restriction number 2.

There are many reasons that the number of Java processors may become zero. One reason could be choice. For example, a customer can choose to eliminate Java processors with an operator command (e.g., IK IPSET JAVA—IP-1-0). Another reason is one of resiliency. For example if a system consists of two processors where one is Java and the other is standard, a fault in either processor will invoke an processor set recovery process that will attempt to recovery the failed processor. If that recovery fails, then the remaining processor will be a standard processor. In any case, when the number of Java processors becomes zero, Java tasks will continue to execute, but the workload will now execute on standard processor contending for processor resources with the standard workload. If one were to use the simplistic metering method described solely based upon the executing processor set, then the customer would be unfairly charged for the Java workload processing that is taking place on standard processors.

The following describes the new features of this invention:

Computer systems are designed by nature to handle a variety of workloads. Although the concepts behind this licensing mechanism extends far beyond this invention, the mechanism described in this invention specifically differentiates and licenses two workloads: Java workload and everything else (standard workload). Furthermore, the multiple workloads are licensed on a system-wide basis where metering parameters can be independently selected for the individual partitions. The structure of the metering key supports multiple partitions, selectable metering parameters for the standard workload, and an optional unmetered Java workload component Furthermore, the key can be extended to support Java metering when that becomes a supported feature.

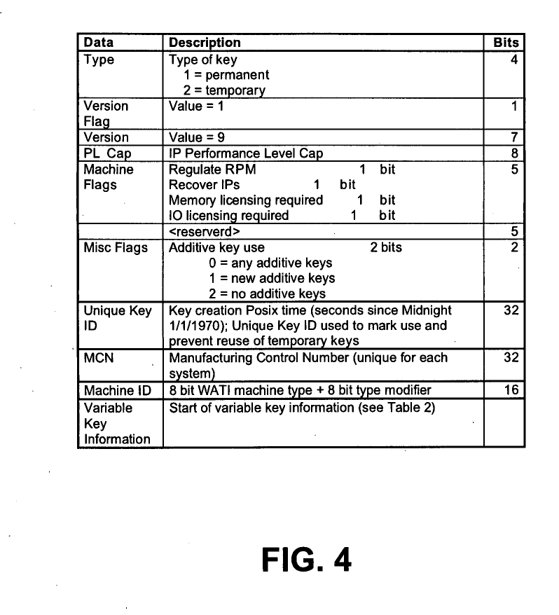

The Java processor set capability is enabled using existing processing power metering keys with a format that supports metering standard workload performance and non-metered Java workload performance. These keys will use the existing version 9 key structure. Words 1 through 4 contains the fixed information for the key (see Fixed Key Information). FIG. 4 illustrates an example of a Fixed Key Information.

Variable Key Information—This information is appended to the fixed information in the key. The variable key information is always in a format that consists of 5 bit group identifier followed by the specific group information. The “Variable Key Information” table displays the groups and the defined structure for each group. The “Group” column shown is the group identifier that is stored in the first five bits of each group section. Multiple images are signified simply by creation of multiple image groups. The value 0 indicates there are no more groups to process.

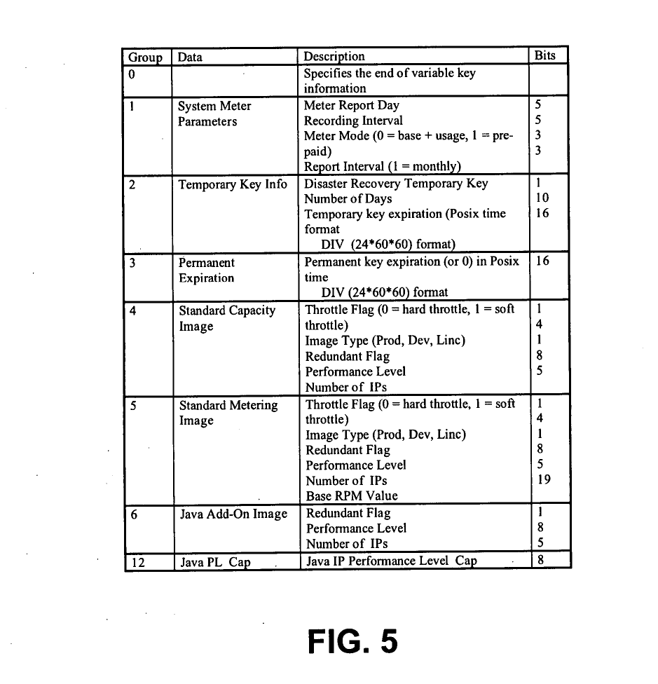

FIG. 5 illustrates an example of a Variable Key Information including the format of variable data in the key. Notice, it is possible with this type of licensing structure to create a key where one partition is a licensed with a standard metering image plus Java workload while the other partition is licensed with a standard capacity image plus Java processors. Furthermore on Libra 690 systems, only one processor key is active at any instance, so it must contain partition instantiation information for all potential partitions.

In the key creation process, once the data for the key parameters are fully determined and the end of the key is signaled, the binary data is the encrypted by the key encryption program. For new metering systems, the key encryption program generates a key that consists of a string that begins with “IP1-” followed by at least 52 apparently random characters.

The following is an example of a new metering key that defines 2 metering partitions, each of which is licensed to include Java processors. The output illustrates the encrypted key and the decrypted key parameters. Notice the key string begins with “IP1-” followed by 52 apparently random characters. When decrypted, these characters decode into the subsequent key parameter information.

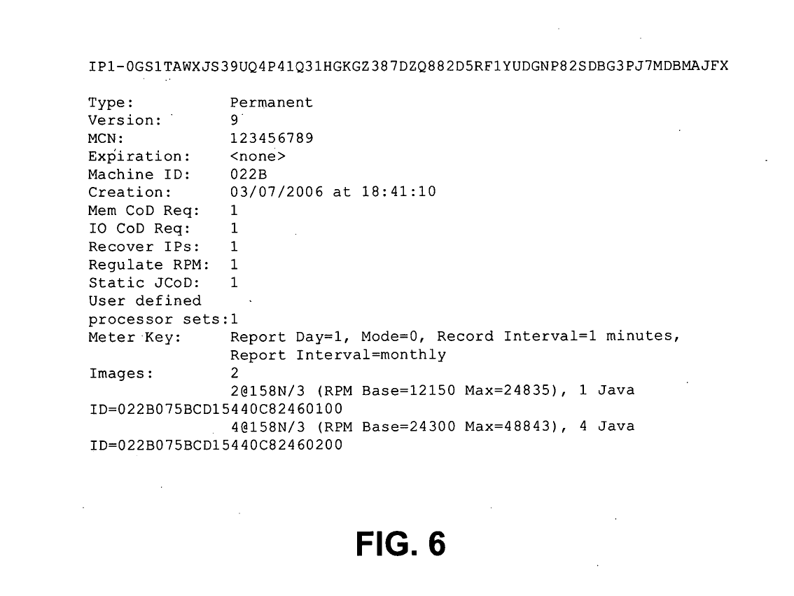

FIG. 6 illustrates an example of a decoded key string according to the present invention. When a key that licenses both standard processing power and Java processors is active, the customer may freely configure which processors are Java processors and which are standard processors. The only constraints are in the in the license itself. The customer cannot configure more Java processors than are contained in the license. However the customer can configure less Java processors or even zero Java processors. If at least one Java processor is configured, then any task that is automatically identified as a Java task will automatically execute on a java processor; otherwise the Java task will execute on the standard processor.

To view the current metering licensing state on a new metering system, the IK IPSHOW ALL operator command can be entered. This is an example of a partition (partition 7) that is configured with 1 Java processor and 2 standard processors running at a level of performance (20K RPM) that is less than the ceiling (25K RPM)—see “CURRENT IMAGE”. A system-wide view of the images that are in use by each partition is also displayed. The active key status and key licensing information is also displayed. The example key consists of two partition images each of which consists of a standard performance rating component (STD RPM rating) and a Java processor count component. Key metering parameters and the key string itself are also displayed.

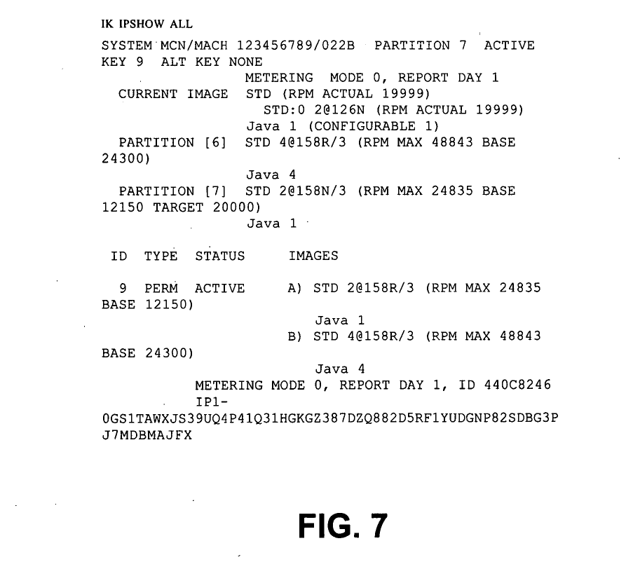

FIG. 7 illustrates an example of Licensing Two Workloads—Metering Standard and Non-Metering Java Licensing of separate workloads is only part of the story. The operating system must somehow logically separate the workloads. For Java workloads in any operating system environment, this must be somehow automatically accomplished based upon Java-related criteria. The criteria may vary from one operating system to another and as such, the actual criteria used for new metering systems selection of which tasks are Java and which are not is not part of this disclosure.

Licensing of separate processor sets results in setting each processor set to a different level of performance. For Java tasks, there is a Java optimized level of performance on Java processors that cannot be achieved at the native level of performance offered on standard processors. Thus Java tasks perform better on Java processors than they do on native standard processors. Furthermore when Java processors are configured, Java tasks only execute on Java processors.

However it is also possible, but unlikely, that extremely critical OS functions execute on Java processors. On a metering system, this crossover standard workload CPU time accumulated against Java processors should count against the standard meters.

When Java processors are not configured, Java tasks continue to execute contending with all tasks on standard processors. On a metering system, it would be unfair that this crossover Java workload CPU time accumulated against standard processors should count against the standard meters.

Ideally it would be good to have one mechanism that would handle both scenarios. This solution does just that. In addition to CPU time accumulators normally associated with every processor (e.g., Idle, IO, User Task, Process Switch, etc.), each processor is allocated additional workload CPU time accumulators. The additional size of the array elements should be (Max number of processors) times (Max number of workloads). The accumulators are internal operating system structures allocated one per processor.

Furthermore because each processor can be set to a different level of performance, each processor is associated with a value that is the current exchange rate or normalization rate value. This value is used to convert value of the current CPU second into the so-called normalized CPU second. The normalized processor time is the time that is actually accumulated for any given target workload process.

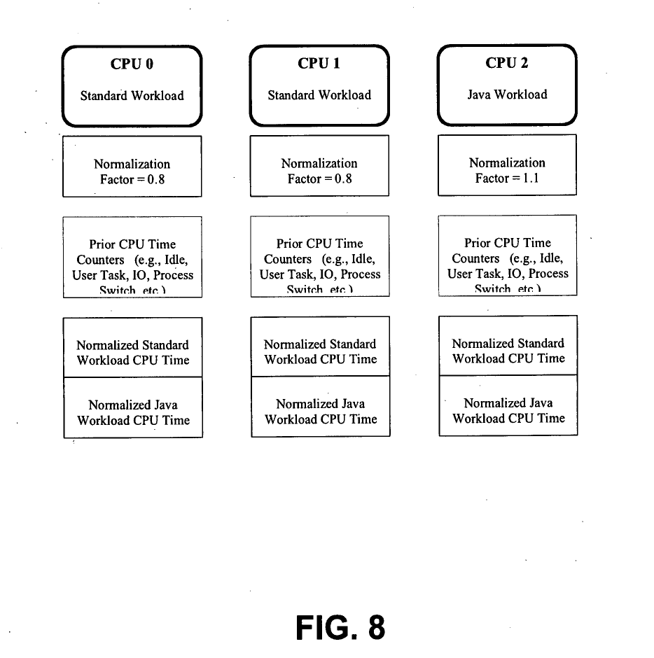

FIG. 8 illustrates an example embodiment of a Dual Workload CPU Sets and CPU Time Data Structures. When a Java task enters the mix and a Java processor exists, the Java task will be scheduled on the Java processor. If the Java task executes on processor for 1 second, then 1 second will be incremented on the CPU 2 user task CPU time counter (the timers that have always existed), but 1 second times the normalization factor (1.1) will be incremented in the normalized Java workload CPU time counter for CPU 2. Similarly, if a standard task executes on CPU 1 for 1 second, then CPU 1 user task CPU time will be incremented by 1 second and normalized standard workload CPU time will be incremented by 1*0.8 or 0.8 seconds for CPU 1.

So what happens when a Java task enters the mix and a Java processor does not exist. In this scenario, the task will be identified as having a target Java processor set, but will contend with every other task for the standard processors. The other tasks will be identified as having a target of standard processor set. Note that accumulation of normalized workload CPU time is by the target processor set. So for every task that executes on the CPU, the task will select one of 2 bucket into which to accumulate the normalized CPU time. Thus, if a Java task executes for 1 second on CPU 2, the user task CPU time will be incremented by 1 second and the normalized Java workload CPU time will be incremented by 1*0.8 or 0.8 seconds. Normalization of CPU times always reflects the actual speed that the CPU is current running at.

Metering systems with Java workloads are only concerned with separating the Java component of the workload out so that accurate metering of the non-Java component can be accomplished. Thus metering systems require the following information: Accumulated normalized CPU time statistics for the standard workload; Reconstitute adjusted CPU time statistics reflecting standard processor set performance level; Standard processor set CPU configuration (how close CPU memory caches are to each other); Standard processor set CPU performance level; and A metering time interval (metering values are updated once every minute)

Based upon the information in FIG. 8, there is no need for users to know internal CPU time accumulator values for every CPU in the system. It is sufficient simply to produce a single system interface that sums the corresponding CPU time accumulator values for every CPU and returns the system-wide information in a single programmatic interface. For new metering systems, this interface is the SYSTEMSTATUS type 25 interface.

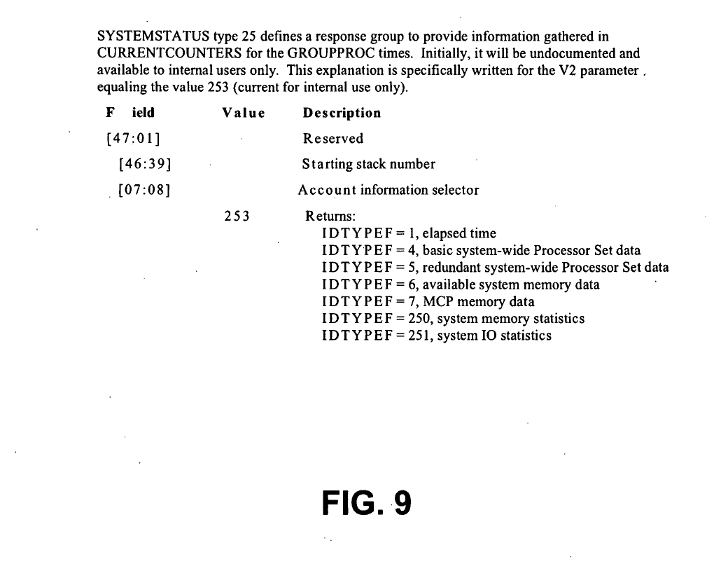

The SYSTEMSTATUS type 25 interface was originally designed to return many CPU utilization counters both for system-wide CPU time accumulation and for individual task CPU time accumulation. This interface has been modified to also return normalized workload CPU time accumulation information that reflects the information illustrated in FIG. 8. It is used by our metering software in calculating the meters. FIG. 9 illustrates an example of a SYSTEMSTATUS Type 25 Normalized Workload CPU Time Documentation.

System Wide Processor Time Group

Groups with an IDTYPEF of REDUNDANTACCOUNTV or SC_REDUNDANTACCOUNTV contain accounts that reflect processor time also billed to individual stack processor time account groups. Groups with an IDTYPEF of SC_SYSTEMWIDEACCOUNTV or SC_REDUNDANTACCOUNTV contain Processor Set information. On prior CoD and metering systems, there may be Processor Set entries from 0 through the largest value indicated by the VALIDPROCSETS mask. On other systems, there will only be Processor Set 0 and VALIDIPSETS will be a 1. The layout of the System Wide Processor Time Group is as follows:

Word 1, field [39:20], include:

| | |
|---|---|
| 13 | *NORMALIZED TIMES* |

Under the IF IDTYPE = SC_SYSTEMWIDEACCOUNTV or
SC_REDUNDANTACCOUNTV:

| | |
|---|---|
| Word 2 | Size of fixed area |
| Word 3 | VALIDPROCSETS |
| Word 4 | PROCMASK |
| Word 5-8 | Standard form name of account type |
| Word 9 | Group size word for Associated account values by |
| | PROCSET |
| Word 10 | System wide Normalized PROCESS TIME by Standard |
| | ProcSET |
| Word 11 | System wide Normalized PROCESS TIME by User:1 |
| | ProcSET |
| Word 12 | System wide Normalized PROCESS TIME by Java |
| | ProcSET |
| Word 13 | System wide Normalized PROCESS TIME by AGL |
| | ProcSET |
| Word 14-25 | 0 |

Now that the metering software has the normalized CPU times for each workload, it can now choose to focus on the workloads it is metering. For new metering systems, only the standard workloads are being metered. The Java workload processor utilization is ignored. For future systems that may change, and the operating system infrastructure is in place to handle that when it occurs. However for new metering systems, only the normalized standard CPU time is used.

Furthermore, the metering software is aware of the performance level of the standard processor set because it is the metering software that originally set both the performance level and the processor normalization factor as part of the licensing. That means that the metering software can also recalculate the original elapsed CPU time based from the normalized workload CPU time. For example if 24 seconds of normalized time have accumulated in the last minute and the normalization factor for the processor set is 0.8 then the actual elapsed CPU time for that processor set is 24/0.8 or 30 seconds. Thus the total user task CPU time for the standard processors for the last minute would have been 30 seconds.

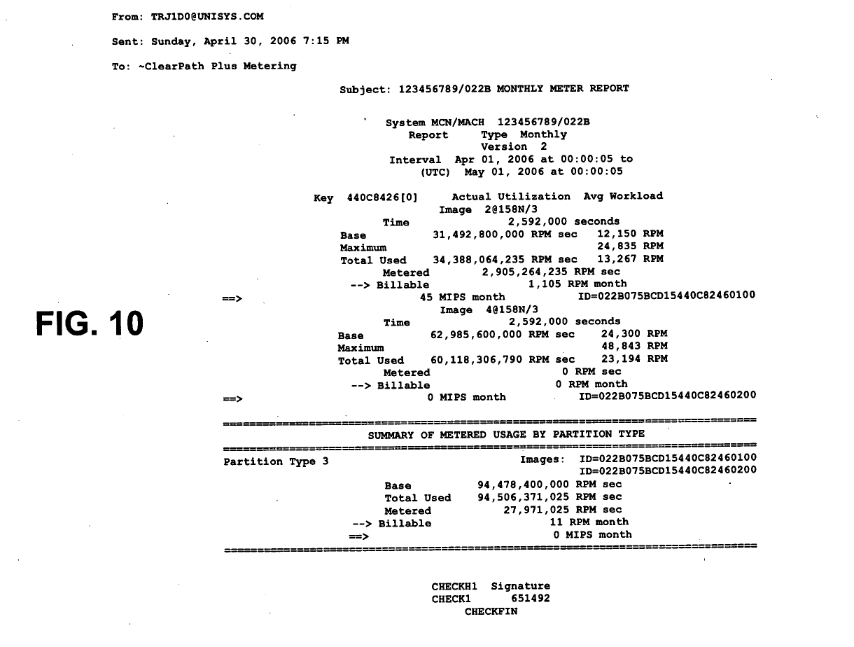

With a recalculated elapsed CPU time (with the Java workload component removed), a known CPU configuration, a known CPU performance level, and a known interval, an incremental meter value can be calculated using our meter tables and can be added to the system meters. FIG. 10 is an illustration of a meter report using the license defined in FIG. 6. Notice that no mention is made in the report of the Java add-on image because that component adds nothing to the metered utilization.

The meter report itself indicates accumulated utilization of the standard workload component of the system over the month. FIG. 10 illustrates an actual meter report from a new metering system that consists of 2 partitions. This represents the same configuration as that licensed in FIGS. 6 and 7. Processing power utilization consists of both a power component “RPM” and a time component “seconds”. Notice that only the utilization of each of the two standard licensed workloads is displayed and no mention is even made of the unmetered Java workload components. Each of the “Image” lines and subsequent lines gives billable information for that image. At the bottom of the report, the sum of the utilization for the two images is displayed and the total billable utilization is displayed for this report.

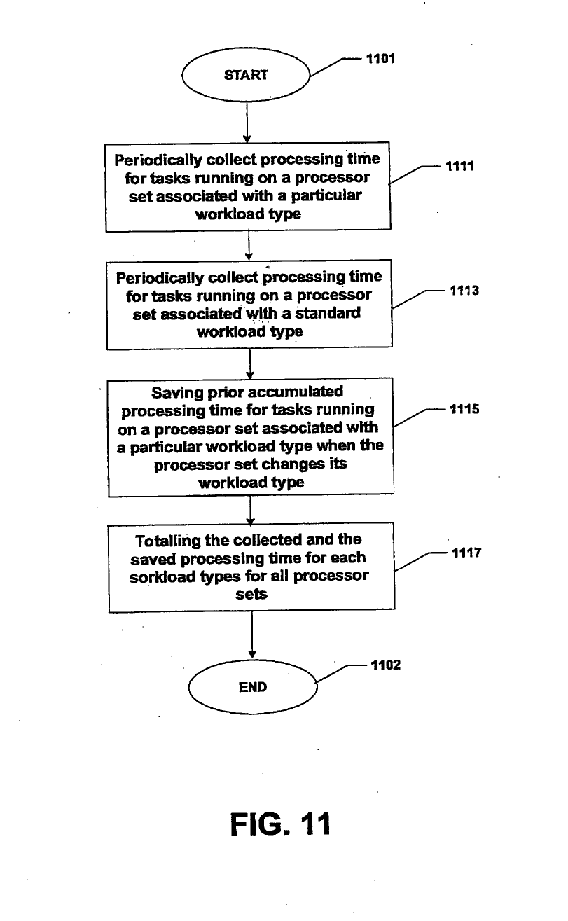

FIG. 11 illustrates a flowchart for an example method for implementing one embodiment of the present invention. A method provides processing metering for tasks from a plurality of workload types. The method begins 1101 and periodically collect processing time for tasks of each of the plurality of workload types running on a processor set associated with the particular workload type in operation 1111. In operation 1113, the method periodically collect processing time for tasks of each of the plurality of workload types by workload type that are running on a standard processor set. When the processor set changes to process a different workload type, the method saves prior accumulated processing time for tasks of a particular workload type running on a processor set associated with the particular workload type in operation 1115. The method totals the collected and the saved processing times in operation 1117 for each of the plurality of workload types from all processor sets. Once the time is totaled, the processing ends 1102.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments

The present invention can be embodied in the form of methods and apparatuses for practicing those methods. The present invention can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the steps in the following method claims, if any, are recited in a particular sequence with corresponding labeling, unless the claim recitations otherwise imply a particular sequence for implementing some or all of those steps, those steps are not necessarily intended to be limited to being implemented in that particular sequence.

What is claimed is:

1. A method for providing processing metering for tasks from a plurality of workload types, the method comprising:
periodically collect processing time for tasks of each of the plurality of workload types running on a processor set associated with the particular workload type;
periodically collect processing time for tasks of each of the plurality of workload types by workload type that are running on a standard processor set;
saving prior accumulated processing time for tasks of a particular workload type running on a processor set associated with the particular workload type when the processor set changes to process a different workload type; and
totaling the collected and the saved processing times for each of the plurality of workload types from all processor sets.

2. The method according to claim 1, wherein the method further comprises generating a metered bill associated with the processing time of standard workload type processing and with the processing time of the particular workload type processing.

3. The method according to claim 2, wherein the processing time for the standard workload type is billed at a first cost level per unit of processing time.

4. The method according to claim 3, wherein the processing time for the particular workload type is billed at a second cost level per unit of processing time.

5. The method according to claim 4, wherein the first cost level is different than the second cost level.

6. The method according to claim 2, wherein the particular workload type is a java task executing upon a dedicated java processor set; and the java processor set executes java tasks of the particular workload type at a first processing rate that is higher than a second processing rate associated with the tasks of the standard workload type.

7. The method according to claim 6, wherein the metered bill uses a first cost level per unit of processing time for generating associated with the processing time for the standard workload type and a second cost level per unit of processing time for generating associated with the processing time for the particular workload type.

8. A data storage media containing computer readable data encoded with instructions that when executed in a computing system implements a method for providing processing metering for tasks from a plurality of workload types, the method comprising:
periodically collect processing time for tasks of each of the plurality of workload types running on a processor set associated with the particular workload type;
periodically collect processing time for tasks of each of the plurality of workload types by workload type that are running on a standard processor set;
saving prior accumulated processing time for tasks of a particular workload type running on a processor set associated with the particular workload type when the processor set changes to process a different workload type; and
totaling the collected and the saved processing times for each of the plurality of workload types from all processor sets.

9. The data storage media according to claim 8, wherein the method further comprises generating a metered bill associated with the processing time of standard workload type processing and with the processing time of the particular workload type processing.

10. The data storage media according to claim 9, wherein the processing time for the standard workload type is billed at a first cost level per unit of processing time.

11. The data storage media according to claim 10, wherein the processing time for the particular workload type is billed at a second cost level per unit of processing time.

12. The data storage media according to claim 11, wherein the first cost level is different than the second cost level.

13. The data storage media according to claim 9, wherein the particular workload type is a java task executing upon a dedicated java processor set; and the java processor set executes java tasks of the particular workload type at a first processing rate that is higher than a second processing rate associated with the tasks of the standard workload type.

14. The data storage media according to claim 13, wherein the metered bill uses a first cost level per unit of processing time for generating associated with the processing time for the standard workload type and a second cost level per unit of processing time for generating associated with the processing time for the particular workload type.

15. A computing system for providing processing metering for tasks from a plurality of workload types, the computing system comprises:
one or more processor set executing processing tasks associated with a standard workload type;
one or more processor sets executing processing tasks associated with a particular workload type; and
a server control module for collecting processing time associated with tasks of the standard workload type and with tasks associated the particular workload type.

16. The computing system according to claim 15, wherein the server control module further processes licensing keys for authorizing the operation of processor sets for performing processing tasks associated with the standard workload type and the operation of processor sets for performing tasks associated with the particular workload type.

17. The computing system according to claim 16, wherein the authorizing the operation of processor sets comprises setting the processing rate to be used by the processor set in executing processing tasks and enabling the size of memory blocks associated the processor sets executing processing tasks according to the processor set workload type.

18. The computing system according to claim 15, wherein the particular workload type corresponds to a java processor set for use in executing java tasks; and the java processor set executes java tasks of the particular workload type at a first processing rate that is higher than a second processing rate associated with the tasks of the standard workload type.

19. The computing system according to claim 17, wherein server control module further generates a metered bill associated with the processing time of standard workload type processing and with the processing time of the particular workload type processing;
the processing time for the standard workload type is billed at a first cost level per unit of processing time and the processing time for the particular workload type is billed at a second cost level per unit of processing time.

20. The computing system according to claim 19, wherein the first cost level is different than the second cost level.
